(19) United States
(12) Patent Application Publication
(10) Pub. No.: US 2017/0290064 A1
(43) Pub. Date: Oct. 5, 2017

(54) METHOD FOR CONFIGURING RANDOM ACCESS RESPONSE WINDOW, BASE STATION AND USER EQUIPMENT

(71) Applicant: SHARP KABUSHIKI KAISHA, Sakai City, Osaka (JP)

(72) Inventors: Renmao LIU, Shanghai (CN); Feng WANG, Shanghai (CN); Qi JIANG, Shanghai (CN)

(73) Assignee: SHARP KABUSHIKI KAISHA, Sakai City, Osaka (JP)

(21) Appl. No.: 15/507,518

(22) PCT Filed: Sep. 17, 2015
(86) PCT No.: PCT/CN2015/089847

§ 371 Date: Feb. 28, 2017

(30) Foreign Application Priority Data
Sep. 26, 2014 (CN) 201410502743.9

(51) Int. Cl. H04W 74/08

(52) U.S. Cl. CPC H04W 74/0833

(57) ABSTRACT

The present disclosure provides a base station. The base station comprises: a configuration unit configured to configure sizes of Random Access Response (RAR) windows for RARs having different coverage enhancement levels; and a transmission unit configured to transmit a Media Access Control (MAC) Protocol Data Unit (PDU) of an RAR over a repetition window within an RAR window. Also provided are a User Equipment (UE) and associated methods.

### TECHNICAL FIELD

The present disclosure relates to wireless communications, and more particularly, to a method for configuring random access response window, a base station and a User Equipment (UE).

### BACKGROUND

With the rapid growth of mobile communications and the enormous development of technology, the world is evolving towards a network society with full connectivity. That is, anyone or anything can obtain information and share data anytime and anywhere. It is expected that, by 2020, there will be 50 billion of interconnected devices, among which only 10 billion will be mobile phones and tablet computers, while others are machines that do not interact with human, but with each other. Hence, there is a topic worth comprehensive research regarding how to design the system to support a huge number of machine communication devices.

In the Long Term Evolution (LTE) standard in the 3^{rd} Generation Partner Project (3GPP), such machine-to-machine communication is referred to as Machine Type Communication (MTC). The MTC is a data communication service without human involvement. A large-scale deployment of MTC UEs can be applied to various fields such as security, tracking, payment, measurement, consumer electronics, and in particular to applications such as video surveillance, supply chain tracking, intelligent metering and remote monitoring. The MTC requires low power consumption and supports low data transmission rate and low mobility. Currently, the LTE system is mainly designed for Human-to-Human (H2H) communication services. Hence, in order to achieve the scale benefit and application prospect of the MTC services, it is important for the LTE network to support the MTC devices to operate at low cost.

Further, some MTC devices are mounted in basements of residential buildings or locations protected by insulating films, metal windows or thick walls of traditional buildings. These devices will suffer significantly higher penetration loss in air interface than conventional device terminals, such as mobile phones and tablets, in the LTE network. The 3GGP has started researches on solution designs and performance evaluations for MTC devices with a 20 dB of additional coverage enhancement. It is to be noted that an MTC device located in an area with poor network coverage has a very low data transmission rate, a very loose delay requirement and a limited mobility. For these MTC characteristics, some signaling and/or channels of the LTE network can be further optimized to better support the MTC services.

For this purpose, in the 3GPP RAN #64 meetings in June, 2014, a new work item for Rel-13 has been proposed for the low complexity and enhanced coverage MTC (see non-patent document: RP-140990, New Work Item on Even Lower Complexity and Enhanced Coverage LTE UE for MTC, Ericsson, NSN). In the description of this work item, the LTE Rel-13 system shall allow MTC UEs supporting 1.4 MHz RF bandwidth in UL/DL (referred to as narrowband MTC UE) to operate over any system bandwidth (e.g., 1.4 MHz, 3 MHz, 5 MHz, 10 MHz, 15 MHz, 20 MHz, etc.) and provide such MTC UEs with coverage enhancement function. A uniform design is desired for low-cost MTC UEs and MTC UEs with coverage enhancement in the system design.

In the conventional LTE network, when an evolved NodeB (eNB) detects a preamble sequence transmitted from a UE, it will transmit, on Physical Downlink Shared Channel (PDSCH), a Random Access Response (RAR), including an index of the detected preamble sequence, time adjustment information for uplink synchronization, an initial uplink resource allocation (for subsequent transmission of msg3) and a Cell-Radio Network Temporary Identifier (C-RNTI).

After transmitting the preamble sequence, the UE needs to use a Random Access-Radio Network Temporary Identifier (RA-RNTI) for monitoring Physical Downlink Control Channel (PDCCH) within a RAR window, so as to receive the RAR message. Here,

RA-RNTI=1+t_id+10*f_id

where:
t_id denotes an index of the first subframe of Physical Random Access Channel (PRACH) for transmitting the preamble, (0 [symbol] t_id<10);
f_id denotes a frequency domain position index of PRACH within that subframe (0 [symbol] f_id<6). For FDD systems, f_id is always zero as there is only one frequency domain position. There is a one-to-one correspondence between RA-RNTIs and time-frequency positions at which the UE transmits the preamble sequence. The UE and the eNB can calculate the RA-RNTI value corresponding to the preamble sequence individually. The UE can receive the RAR message based on the calculated RA-RNTI value. If the preamble sequence index in the RAR is the same as the preamble sequence transmitted by the UE itself, the UE can adopt the uplink time adjustment information in the RAR and initiate a corresponding collision resolution procedure.

The RAR window has a length of ra-ResponseWindowSize subframes, starting with the subframe in which the UE transmits the preamble sequence+3 subframes. For the definition of ra-ResponseWindowSize, reference can be made to Table 1. If the UE fails to receive any RAR as a reply within the period of the RAR window, it considers this as an unsuccessful access. In the RAR message, there may be a back-off indicator (backoffindicator), indicating a time range in which the UE shall wait before retransmitting the preamble. If a particular access has failed, the UE needs to wait a time period before it can perform the next preamble access. This time period is indicated by backoffindicator. The UE can select a value randomly in the range from 0 to backoffindicator. In this way, the probability that the colliding UEs may retransmit the preamble sequence simultaneously again can be reduced.

TABLE 1
RACH-ConfigCommon Information Element

-- ASN1START

| | |
|---|---|
| RACH-ConfigCommon ::= | SEQUENCE { |

| | |
|---|---|
| preambleInfo | SEQUENCE { |

| | |
|---|---|
| numberOfRA-Preambles | ENUMERATED { |

n4, n8, n12, n16 ,n20, n24, n28,
n32, n36, n40, n44, n48, n52 , n56,
n60, n64},

| | |
|---|---|
| preamblesGroupAConfig | SEQUENCE { |

| | |
|---|---|
| sizeOfRA-PreamblesGroupA | ENUMERATED { |

n4, n8, n12, n16 ,n20, n24, n28,
n32, n36, n40, n44, n48, n52, n56,
n60},

| | |
|---|---|
| messageSizeGroupA | ENUMERATED {b56, b144, b208, b256}, |
| messagePowerOffsetGroupB | ENUMERATED { |

minusinfinity, dB0, dB5, dB8, dB10, dB12,
dB15, dB18},

...

| | | |
|---|---|---|
| } | OPTIONAL | -- Need OP |

| }, | |
|---|---|
| powerRampingParameters | PowerRampingParameters, |
| ra-SupervisionInfo | SEQUENCE { |

| | |
|---|---|
| preambleTransMax | PreambleTransMax, |
| ra-ResponseWindowSize | ENUMERATED { |

sf2, sf3, sf4, sf5, sf6, sf7,
sf8, sf10},

| | |
|---|---|
| mac-ContentionResolutionTimer | ENUMERATED { |

sf8, sf16, sf24, sf32, sf40, sf48,
sf56, sf64}

| }, | |
|---|---|
| maxHARQ-Msg3Tx | INTEGER (1..8), |

...

}

| | |
|---|---|
| RACH-ConfigCommonSCell-r11 ::= | SEQUENCE { |

| | |
|---|---|
| powerRampingParameters-r11 | PowerRampingParameters, |
| ra-SupervisionInfo-r11 | SEQUENCE { |

| | |
|---|---|
| preambleTransMax-r11 | PreambleTransMax |

},
...

}

| | |
|---|---|
| PowerRampingParameters ::= | SEQUENCE { |

| | |
|---|---|
| powerRampingStep | ENUMERATED {dB0, dB2,dB4, dB6}, |
| preambleInitialReceivedTargetPower | ENUMERATED { |

dBm-120, dBm-118, dBm-116, dBm-114, dBm-112,
dBm-110, dBm-108, dBm-106, dBm-104, dBm-102,
dBm-100, dBm-98, dBm-96, dBm-94,
dBm-92, dBm-90}

}

| | |
|---|---|
| PreambleTransMax ::= | ENUMERATED { |

n3, n4, n5, n6, n7, n8, n10, n20, n50,
n100, n200}

-- ASN1STOP

RACH-ConfigCommon Field Description

...
ra-ResponseWindowSize
Duration of RAR window. In 3GPP TS 36.321. its value is indicated in units of subframes. The value sf2
corresponds to 2 subframes; the value sf3 corresponds to 3 subframes, and so on. The same value applies
to each serving cell (although associated functions are performed individually for each cell).
...

For an MTC UE with coverage enhancement, it is desired to increase received signal strength of a physical channel for the MTC UE by utilizing enhancement techniques. In the discussion about MTC in Rel-12, the received signal strength of MTC physical channels is increased mainly by means of subframe bundling or repetitive transmissions. MTC UEs at different geographical locations may require different coverage enhancement levels. Accordingly, the MTC UEs in one single cell can be divided into a number of different coverage enhancement levels requiring different numbers of repetitive transmissions, respectively. A coverage enhancement level can also be represented as a repetition level. For example, PRACHs for MTC UEs with coverage enhancement can be divided into four repetition levels, 0, 1, 2 and 3, corresponding to 0 dB, 5 dB, 10 dB and 15 dB of coverage enhancement, respectively. A time interval from a transmission starting subframe to a transmission ending subframe for a particular repetition level is referred to as a repetition window. Then, different repetition levels will have different sizes of repetition windows. A PRACH repetition window for a particular repetition level has RAR transmissions corresponding to the repetition level. When compared with the conventional LTE system, the Rel-13 LTE system supporting coverage enhanced MTC has a different time granularity for physical channel transmission for MTC UEs with coverage enhancement. The conventional system measures a transmission in time units of subframes, whereas the time granularity for physical channel transmission for coverage enhanced MTC is a repetition window. Hence, for the coverage enhanced MTC, it is desired to reconsider the design of RAR window for MTC UEs with coverage enhancement.

### SUMMARY

In an aspect of the present disclosure, a base station is provided. The base station comprises: a configuration unit configured to configure sizes of Random Access Response (RAR) windows for RARs having different coverage enhancement levels; and a transmission unit configured to transmit a Media Access Control (MAC) Protocol Data Unit (PDU) of an RAR over a repetition window within an RAR window.

Preferably, a size of an RAR window is represented as a number of RAR repetition windows.

Preferably, the configuration unit is configured to configure different sizes of RAR windows for different coverage enhancement levels of RARs.

Preferably, the configuration unit is configured to configure the same size of RAR windows for different coverage enhancement levels of RARs.

Preferably, different coverage enhancement levels of Physical Random Access Channels (PRACHs) have the same or different back-off time parameter tables.

Preferably, values in each back-off time parameter table are measured in units of PRACH repetition windows.

In another aspect of the present disclosure, a User Equipment (UE) is provided. The UE comprises: a reception unit configured to monitor Physical Downlink Control Channel (M-PDCCH) or Physical Downlink Shared Channel (PDSCH) for Random Access Response (RAR) over one or more repetition windows within an RAR window; and an extraction unit configured to read a size of the RAR window. The size of the RAR window corresponds to a coverage enhancement level of the RAR.

Preferably, the size of the RAR window is represented as a number of RAR repetition windows.

Preferably, different coverage enhancement levels of RARs have different sizes of RAR windows.

Preferably, different coverage enhancement levels of RARs have the same size of RAR windows.

Preferably, different coverage enhancement levels of RARs have the same or different back-off time parameter tables.

Preferably, values in each back-off time parameter table are measured in units of Physical Random Access Channel (PRACH) repetition windows.

In another aspect of the present disclosure, a method performed by a base station is provided. The method comprises: configuring sizes of Random Access Response (RAR) windows for RARs having different coverage enhancement levels; and transmitting a Media Access Control (MAC) Protocol Data Unit (PDU) of an RAR over a repetition window within an RAR window.

Preferably, a size of an RAR window is represented as a number of RAR repetition windows.

Preferably, different sizes of RAR windows are configured for different coverage enhancement levels of RARs.

Preferably, the same size of RAR windows is configured for different coverage enhancement levels of RARs.

Preferably, different coverage enhancement levels of Physical Random Access Channels (PRACHs) have the same or different back-off time parameter tables.

Preferably, values in each back-off time parameter table are measured in units of PRACH repetition windows.

In another aspect of the present disclosure, a method performed by a User Equipment (UE) is provided. The method comprises: monitoring Physical Downlink Control Channel (M-PDCCH) or Physical Downlink Shared Channel (PDSCH) for Random Access Response (RAR) over one or more repetition windows within an RAR window; and reading a size of the RAR window. The size of the RAR window corresponds to a coverage enhancement level of the RAR.

Preferably, the size of the RAR window is represented as a number of RAR repetition windows.

Preferably, different coverage enhancement levels of RARs have different sizes of RAR windows.

Preferably, different coverage enhancement levels of RARs have the same size of RAR windows.

Preferably, different coverage enhancement levels of RARs have the same or different back-off time parameter tables.

Preferably, values in each back-off time parameter table are measured in units of Physical Random Access Channel (PRACH) repetition windows.

### BRIEF DESCRIPTION OF THE DRAWINGS

The above and other objects, features and advantages will be more apparent from the following description of embodiments with reference to the figures, in which:

FIG. 1 shows a block diagram of a base station according to an embodiment of the present disclosure;

FIG. 2 shows a block diagram of a UE according to an embodiment of the present disclosure;

FIG. 3 is a schematic diagram showing different sizes of RAR windows configured for different coverage enhancement levels of repetition windows according to an embodiment of the present disclosure;

FIG. 4 is a schematic diagram showing different sizes of RAR windows configured for different coverage enhancement levels of subframes according to an embodiment of the present disclosure;

FIG. 5 is a schematic diagram showing the same size of RAR windows configured for different coverage enhancement levels of repetition windows according to an embodiment of the present disclosure;

FIG. 6 is a schematic diagram showing the same size of RAR windows configured for different coverage enhancement levels of subframes according to an embodiment of the present disclosure;

FIG. 7 is a flowchart illustrating a method performed by a base station according to an embodiment of the present disclosure; and

FIG. 8 is a flowchart illustrating a method performed by a UE according to an embodiment of the present disclosure.

### DETAILED DESCRIPTION

In the following, preferred embodiments of the present disclosure will be described in detail with reference to the drawings. It should be noted that the following embodiments are illustrative only, rather than limiting the scope of the present disclosure. In the following description, details of well known techniques which are not directly relevant to the present invention will be omitted so as not to obscure the concept of the invention.

In the following, a number of embodiments of the present invention will be detailed in an exemplary application environment of LTE mobile communication system and its subsequent evolutions. Herein, it is to be noted that the present invention is not limited to the application exemplified in the embodiments. Rather, it is applicable to other communication systems, such as the future 5G cellular communication system.

FIG. 1 is a block diagram of a base station 100 according to an embodiment of the present disclosure. As shown in FIG. 1, the base station 100 includes a configuration unit 110 and a transmission unit 120. It can be appreciated by those skilled in the art that the base station 100 further includes other functional units necessary for its functionality, e.g., various processors, memories and the like. However, details of such well-known elements will be omitted here for simplicity.

The configuration unit 110 can configure sizes of Random Access Response (RAR) windows for RARs having different coverage enhancement levels. The configuration unit 110 can also configure back-off indicators for different coverage enhancement levels of RARs. Further, the configuration unit 110 can configure other configuration information.

In the conventional LTE system, an RAR window refers to a time period having a length of ra-ResponseWindowSize subframes, starting with the subframe in which the UE transmits the preamble sequence+3 subframes. After transmitting the preamble sequence, the UE needs to monitor PDCCH within the RAR window for receiving an RAR message.

For an MTC UE with coverage enhancement, a number of repetitive transmissions are required for its uplink and downlink physical channels, in order to meet the requirements of coverage enhancement of the channels. UEs at different geographical locations need different degrees of channel coverage enhancement. In other words, UEs at different geographical locations need different numbers of repetitive transmissions for physical channels. Hence, the degrees of coverage enhancement of physical channels can be divided into a number of coverage enhancement levels. Physical channels having different coverage enhancement levels require different numbers of repetitive transmissions. For example, Physical Random Access Channels (PRACHs) can be divided into four coverage enhancement levels, CE0, CE1, CE2 and CE3. Each of the coverage enhancement levels of PRACHs corresponds to a PRACH repetition window having a fixed window length. Physical channels with different coverage enhancement levels have different window lengths of repetition windows. Each PRACH having a coverage enhancement level has an RAR having a corresponding coverage enhancement level. Each RAR having a coverage enhancement level corresponds to a repetition window having a fixed window length for Physical Downlink Shared Channel (PDSCH) carrying the RAR, or referred to as RAR repetition window for short. Alternatively, each RAR having a coverage enhancement level corresponds to a repetition window having a fixed window length for (E)PDCCH (M-PDCCH) for scheduling PDSCH carrying the RAR, or referred to as RAR repetition window for short. Alternatively, each RAR having a coverage enhancement level corresponds to a repetition window having a fixed window length for (E)PDCCH (M-PDCCH) for scheduling PDSCH carrying the RAR and a repetition window for the PDSCH scheduled by the M-PDCCH, or referred to as RAR repetition window for short.

Here, a repetition window refers to a time interval between the first transmission and the last transmission of data and/or signaling transmission at a particular coverage enhancement level.

An RAR repetition window refers to a time interval between the first transmission and the last transmission of an RAR transmission at a particular coverage enhancement level. Here, the RAR transmission includes an (E)PDCCH (M-PDCCH) for scheduling PDSCH carrying the RAR and the PDSCH scheduled by the M-PDCCH

A repetition window for a physical channel can be represented as a radio frame number+a subframe number of the first transmission of the physical channel and a radio frame number+a subframe number for the last transmission.

Alternatively, a repetition window for a physical channel can be represented as a radio frame number+a subframe number of the first transmission of the physical channel and the number of repetitive transmissions required for the physical channel.

Alternatively, a repetition window for a physical channel can be represented as a radio frame number+a subframe number of the first transmission of the physical channel, the number of repetitive transmissions required for the physical channel, and an available subframe indication for the physical channel. The available subframe indication for the physical channel can be implemented by means of bitmapping. That is, for a bit corresponding to a particular subframe, the bit being 1 indicates that the subframe is available for transmission of the physical channel, whereas the bit being 0 indicates that the subframe is unavailable for transmission of the physical channel.

An RAR window for an MTC UE with coverage enhancement can be represented as the number of repetition windows or subframes for PDSCH carrying the RAR. Alternatively, an RAR window for an MTC UE with coverage enhancement can be represented as the number of repetition windows or subframes for (E)PDCCH (M-PDCCH) for scheduling PDSCH carrying the RAR.

The size of RAR window represented as the number of repetition windows is shown in Table 2 below. In this case, the RAR window can be described as starting with the last subframe of a number of repetitive transmissions of a preamble sequence over PRACH by a UE+k subframes and having a length of ra-ResponseWindowSize-MTC repetition windows, where k is a constant which can be a preset value or can be configured by a base station.

The size of RAR window represented as the number of subframes is shown in Table 3 below. Unlike in the conventional LTE system, the value of subframe needs to be increased here. In this case, the RAR window can be described as starting with the last subframe of a number of repetitive transmissions of a preamble sequence over PRACH by a UE+k subframes and having a length of ra-ResponseWindowSize-MTC subframes, where k is a constant which can be a preset value or can be configured by a base station.

The base station can configure the same or different sizes of RAR windows for different coverage enhancement levels of RARs (or different coverage enhancement levels of PRACHs). The base station can also configure the same or different back-off time parameter tables for different coverage enhancement levels of PRACHs (or different coverage enhancement levels of PRACHs).

TABLE 2
RACH-ConfigCommon Information Element

-- ASN1START

| | |
|---|---|
| RACH-ConfigCommon ::= | SEQUENCE { |

| | |
|---|---|
| preambleInfo | SEQUENCE { |

| | |
|---|---|
| numberOfRA-Preambles | ENUMERATED { |

n4, n8, n12 , n16 ,n20, n24, n28,
n32, n36, n40, n44, n48, n52, n56,
n60, n64},

| | |
|---|---|
| preamblesGroupAConfig | SEQUENCE { |

| | |
|---|---|
| sizeOfRA-PreamblesGroupA | ENUMERATED { |

n4, n8, n12, n16 ,n20, n24, n28,
n32, n36, n40, n44, n48, n52, n56,
n60},

| | |
|---|---|
| messageSizeGroupA | ENUMERATED {b56, b144, b208, b256}, |
| messagePowerOffsetGroupB | ENUMERATED { |

minusinfinity, dB0, dB5, dB8, dB10, dB12,
dB15, dB18},

...

| | | |
|---|---|---|
| } | OPTIONAL | -- Need OP |

| }, | |
|---|---|
| powerRampingParameters | PowerRampingParameters, |
| ra-SupervisionInfo | SEQUENCE { |

| | |
|---|---|
| preambleTransMax | PreambleTransMax, |
| ra-ResponseWindowSize | ENUMERATED { |

sf2, sf3, sf4, sf5, sf6, sf7,
sf8, sf10},

| | |
|---|---|
| ra-ResponseWindowSize-MTC | ENUMERATED {rw2, rw3, rw4, rw5, rw6, rw7, rw8, rw10}, |

| | |
|---|---|
| mac-ContentionResolutionTimer | ENUMERATED { |

| | sf8, sf16, sf24, sf32, sf40, sf48, |
|---|---|
| }, | sf56, sf64} |

| | |
|---|---|
| maxHARQ-Msg3Tx | INTEGER (1..8), |

...

}

| | |
|---|---|
| RACH-ConfigCommonSCell-r11 ::= | SEQUENCE { |

| | |
|---|---|
| powerRampingParameters-r11 | PowerRampingParameters, |
| ra-SupervisionInfo-r11 | SEQUENCE { |

| | |
|---|---|
| preambleTransMax-r11 | PreambleTransMax |

},
...

}

| | |
|---|---|
| PowerRampingParameters ::= | SEQUENCE { |

| | |
|---|---|
| powerRampingStep | ENUMERATED {dB0, dB2,dB4, dB6}, |
| preambleInitialReceivedTargetPower | ENUMERATED { |

dBm-120, dBm-118, dBm-116, dBm-114, dBm-112,
dBm-110, dBm-108, dBm-106, dBm-104, dBm-102,
dBm-100, dBm-98, dBm-96, dBm-94,
dBm-92, dBm-90}

}

| | |
|---|---|
| PreambleTransMax ::= | ENUMERATED { |

n3, n4, n5, n6, n7, n8, n10, n20, n50,
n100, n200}

-- ASN1STOP

RACH-ConfigCommon Field Description

...
ra-ResponseWindowSize
Duration of RAR window. In 3GPP TS 36.321. its value is indicated in units of subframes. The value sf2
corresponds to 2 subframes; the value sf3 corresponds to 3 subframes, and so on. The same value applies
to each serving cell (although associated functions are performed individually for each cell).
ra-ResponseWindowSize-MTC
Duration of RAR window. In 3GPP TS 36.321. its value is indicated in units of repetition windows. The
value rw2 corresponds to 2 repetition windows; the value rw3 corresponds to 3 repetition windows, and so
on. The same value applies to each repetition level (although associated functions are performed
individually for each repetition level).
...

TABLE 3
RACH-ConfigCommon Information Element

-- ASN1START

| | |
|---|---|
| RACH-ConfigCommon ::= | SEQUENCE { |

| | |
|---|---|
| preambleInfo | SEQUENCE { |

| | |
|---|---|
| numberOfRA-Preambles | ENUMERATED { |

n4, n8, n12, n16 ,n20, n24, n28,
n32, n36, n40, n44, n48, n52, n56,
n60, n64},

| | |
|---|---|
| preamblesGroupAConfig | SEQUENCE { |

| | |
|---|---|
| sizeOfRA-PreamblesGroupA | ENUMERATED { |

n4, n8, n12, n16 ,n20, n24, n28,
n32, n36, n40, n44, n48, n52, n56,
n60},

| | |
|---|---|
| messageSizeGroupA | ENUMERATED {b56, b144, b208, b256}, |
| messagePowerOffsetGroupB | ENUMERATED { |

minusinfinity, dB0, dB5, dB8, dB10, dB12,
dB15, dB18},

...

| | | |
|---|---|---|
| } | OPTIONAL | -- Need OP |

| }, | |
|---|---|
| powerRampingParameters | PowerRampingParameters, |
| ra-SupervisionInfo | SEQUENCE { |

| | |
|---|---|
| PreambleTransMax | PreambleTransMax, |
| ra-ResponseWindowSize | ENUMERATED { |

sf2, sf3, sf4, sf5, sf6, sf7,
sf8, sf10},

| | |
|---|---|
| ra-ResponseWindowSize-MTC | ENUMERATED {sf20, sf50, sf80, sf120, sf160, sf200. |

sf250, sf300},

| | |
|---|---|
| mac-ContentionResolutionTimer | ENUMERATED { |

sf8, sf16, sf24, sf32, sf40, sf48,
sf56, sf64}

| }, | |
|---|---|
| maxHARQ-Msg3Tx | INTEGER (1..8), |

...

}

| | |
|---|---|
| RACH-ConfigCommonSCell-r11 ::= | SEQUENCE { |

| | |
|---|---|
| powerRampingParameters-r11 | PowerRampingParameters, |
| ra-SupervisionInfo-r11 | SEQUENCE { |

| | |
|---|---|
| preambleTransMax-r11 | PreambleTransMax |

},
...

}

| | |
|---|---|
| PowerRampingParameters ::= | SEQUENCE { |

| | |
|---|---|
| powerRampingStep | ENUMERATED {dB0, dB2,dB4, dB6}, |
| preambleInitialReceivedTargetPower | ENUMERATED { |

dBm-120, dBm-118, dBm-116, dBm-114, dBm-112,
dBm-110, dBm-108, dBm-106, dBm-104, dBm-102,
dBm-100, dBm-98, dBm-96, dBm-94,
dBm-92, dBm-90}

}

| | |
|---|---|
| PreambleTransMax ::= | ENUMERATED { |

n3, n4, n5, n6, n7, n8, n10, n20, n50,
n100, n200}

-- ASN1STOP

RACH-ConfigCommon Field Description

...
ra-ResponseWindowSize
Duration of RAR window. In 3GPP TS 36.321. its value is indicated in units of subframes. The value sf2
corresponds to 2 subframes; the value sf3 corresponds to 3 subframes, and so on. The same value applies
to each serving cell (although associated functions are performed individually for each cell).
ra-ResponseWindowSize-MTC
Duration of RAR window. In 3GPP TS 36.321. its value is indicated in units of subframes. The value sf20
corresponds to 20 subframes; the value sf50 corresponds to 50 subframes, and so on. The same value
applies to each repetition level (although associated functions are performed individually for each repetition
level).
...

After receiving the random access preamble sequence transmitted from the UE, the transmission unit 120 transmits a Media Access Control (MAC) Protocol Data Unit (PDU) of an RAR repeatedly for a number of times over an RAR repetition window within an RAR window that corresponds to the RAR preamble sequence, starts with the last subframe of the last one or more repetitive receptions of the preamble sequence by the base station over PRACH+k subframes and has ra-ResponseWindowSize-MTC RAR repetition windows, where k is a constant which can be a preset value or can be configured by the base station. Each MAC PDU consists of one MAC header, zero or more MAC RARs and an optional padding field. The exact number of repetitive transmissions is dependent on the number of repetitive transmissions configured for the repetition window of the coverage enhancement level.

Alternatively, after receiving the random access preamble sequence transmitted from the UE, the transmission unit 120 transmits a Media Access Control (MAC) Protocol Data Unit (PDU) of an RAR repeatedly for a number of times over one of n RAR repetition windows within an RAR window that corresponds to the RAR preamble sequence, starts with the last subframe of the last one or more repetitive receptions of the preamble sequence by the base station over PRACH+k subframes and has ra-ResponseWindowSize-MTC subframes, where k is a constant which can be a preset value or can be configured by the base station and n is an integer value depending on ra-ResponseWindowSize-MTC, the window length of the RAR repetition window and an interval between two neighboring RAR repetition windows. Each MAC PDU consists of one MAC header, zero or more MAC RARs and an optional padding field. The exact number of repetitive transmissions is dependent on the number of repetitive transmissions configured for the repetition window of the coverage enhancement level.

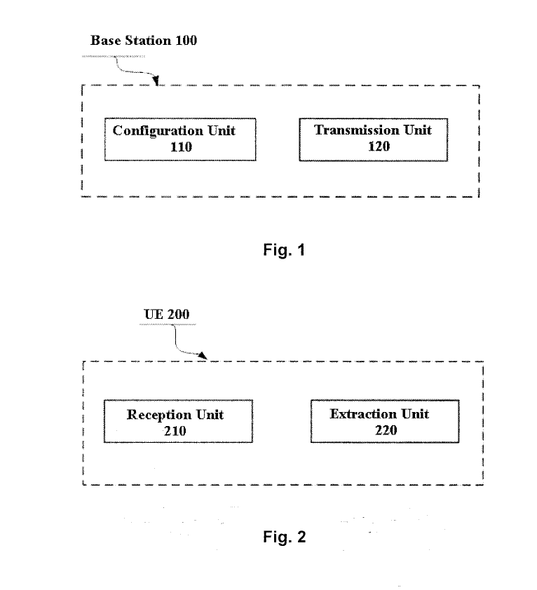

FIG. 2 is a block diagram of a UE 200 according to an embodiment of the present disclosure. As shown in FIG. 2, the UE 200 includes a reception unit 210 and an extraction unit 220. It can be appreciated by those skilled in the art that the UE 200 further includes other functional units necessary for its functionality, e.g., various processors, memories and the like. However, details of such well-known elements will be omitted here for simplicity.

Preferably, in the reception unit 210, after transmitting a random access preamble sequence, the UE monitors (E)PDCCH (M-PDCCH) or PDSCH for an RAR over ra-ResponseWindowSize-MTC RAR repetition windows within an RAR window that corresponds to the RAR preamble sequence, starts with the last subframe of the last one or more repetitive transmissions of the preamble sequence by the UE over PRACH+k subframes and has ra-ResponseWindowSize-MTC RAR repetition windows, where k is a constant which can be a preset value or can be configured by the base station. Each MAC PDU consists of one MAC header, zero or more MAC RARs and an optional padding field. The exact number of repetitive transmissions is dependent on the number of repetitive transmissions configured for the repetition window of the coverage enhancement level.

The (E)PDCCH (M-PDCCH) refers to (E)PDCCH (M-PDCCH) for scheduling the PDSCH carrying the RAR message. The (E)PDCCH can be an EPDCCH defined in the conventional LTE system or a newly designed narrow band PDCCH (M-PDCCH).

The PDSCH is a PDSCH carrying the RAR message without being scheduled by an (E)PDCCH (M-PDCCH). In this case, without scheduling by (E)PDCCH (M-PDCCH), the UE can directly monitor the PDSCH carrying the RAR message. Alternatively, in the reception unit 210, after transmitting a random access preamble sequence, the UE monitors (E)PDCCH (M-PDCCH) or PDSCH for an RAR over n RAR repetition windows within an RAR window that corresponds to the RAR preamble sequence, starts with the last subframe of the last one or more repetitive transmissions of the preamble sequence by the UE over PRACH+k subframes and has ra-ResponseWindowSize-MTC RAR subframes, where k is a constant which can be a preset value or can be configured by the base station and n is an integer value depending on ra-ResponseWindowSize-MTC, the window length of the RAR repetition window and an interval between two neighboring RAR repetition windows. Each MAC PDU consists of one MAC header, zero or more MAC RARs and an optional padding field. The exact number of repetitive transmissions is dependent on the number of repetitive transmissions configured for the repetition window of the coverage enhancement level.

The (E)PDCCH (M-PDCCH) refers to (E)PDCCH (M-PDCCH) for scheduling the PDSCH carrying the RAR message. The (E)PDCCH (M-PDCCH) can be an EPDCCH defined in the conventional LTE system or a newly designed narrow band PDCCH (M-PDCCH).

The PDSCH is a PDSCH carrying the RAR message without being scheduled by an (E)PDCCH (M-PDCCH). In this case, without scheduling by (E)PDCCH (M-PDCCH), the UE can directly monitor the PDSCH carrying the RAR message.

In the extraction unit 220, the UE reads configuration information of a size of the RAR window and/or back-off indication information based on a coverage enhancement level of its RAR. Alternatively, the UE reads configuration information of a size of the RAR window and back-off indication information based on a coverage enhancement level of PRACH over which the UE transmits the random access preamble sequence.

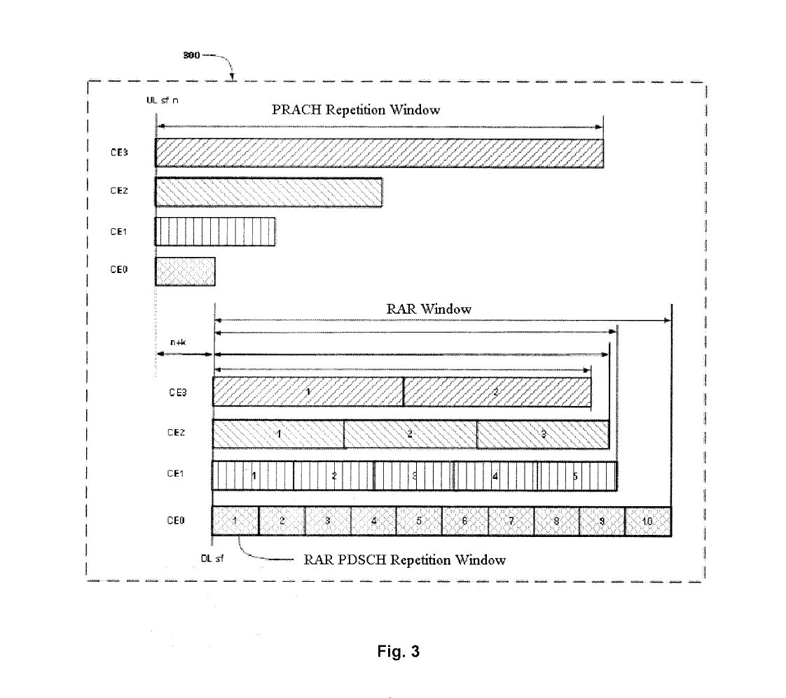

In the following, examples of different sizes of RAR windows configured for different coverage enhancement levels of repetition windows (subframes) according to an embodiment of the present disclosure will be described with reference to FIGS. 3-6.

FIG. 3 is a schematic diagram showing different sizes of RAR windows configured for different coverage enhancement levels of repetition windows according to an embodiment of the present disclosure. In this embodiment, PRACHs are divided into four coverage enhancement levels, CE0, CE1, CE2 and CE3. Each of the coverage enhancement levels corresponds to a PRACH repetition window having a fixed window length. Each PRACH having a coverage enhancement level has an RAR having a corresponding coverage enhancement level. Each RAR having a coverage enhancement level corresponds to an RAR repetition window having a fixed window length.

The base station 100 can configure different sizes of RAR windows for different coverage enhancement levels of RARs (or different coverage enhancement levels of PRACHs). In the example shown in FIG. 3, the size of an RAR window refers to the number of RAR repetition windows. For example, the base station 100 can configure a size 10 of RAR window for the coverage enhancement level CE0 of RAR, i.e., 10 RAR repetition windows for this coverage enhancement level. Accordingly, 5 can be configured for CE1 (i.e., 5 RAR repetition windows for this coverage enhancement level), 3 for CE2 (i.e., 3 RAR repetition windows for this coverage enhancement level) and 2 for CE3 (i.e., 2 RAR repetition windows for this coverage enhancement level).

The configuration information for the size of the RAR window can be preconfigured or can be notified to the MTC UE via MIB (Master Information Block) or SIBx (System Information Block, SIB, 1, and/or SIB2 and/or other SIBs), MAC PDU, or dedicated RRC signaling.

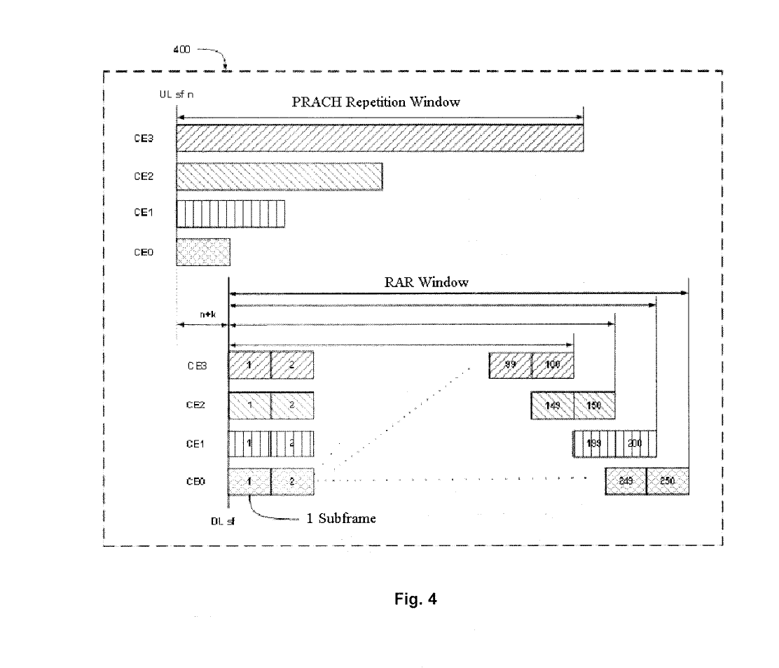

FIG. 4 is a schematic diagram showing different sizes of RAR windows configured for different coverage enhancement levels of subframes according to an embodiment of the present disclosure. As shown in FIG. 4, in this embodiment, PRACHs are divided into four coverage enhancement levels, CE0, CE1, CE2 and CE3. Each of the coverage enhancement levels corresponds to a PRACH repetition window having a fixed window length. Each PRACH having a coverage enhancement level has an RAR having a corresponding coverage enhancement level. Each RAR having a coverage enhancement level corresponds to an RAR repetition window having a fixed window length.

The base station 100 can configure different sizes of RAR windows for different coverage enhancement levels of RARs (or different coverage enhancement levels of PRACHs). In the example shown in FIG. 4, the size of an RAR window refers to the number of downlink subframes. For example, the base station 100 can configure a size 250 of RAR window for the coverage enhancement level CE0 of RAR, i.e., 250 downlink subframes. Accordingly, 200 can be configured for CE1 (i.e., 200 downlink subframes), 150 for CE2 (i.e., 150 downlink subframes) and 100 for CE3 (i.e., 100 downlink subframes).

The configuration information for the size of the RAR window can be preconfigured or can be notified to the MTC UE via MIB (Master Information Block) or SIBx (System Information Block, SIB, 1, and/or SIB2 and/or other SIBs), MAC PDU, or dedicated RRC signaling.

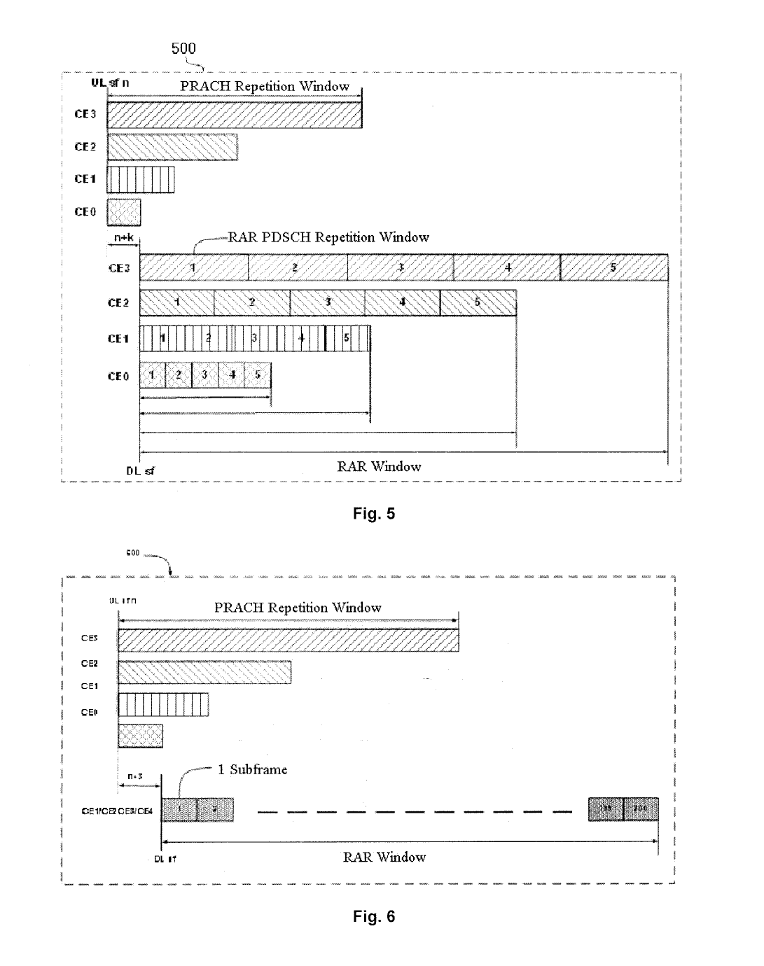

FIG. 5 is a schematic diagram showing the same size of RAR windows configured for different coverage enhancement levels of repetition windows according to an embodiment of the present disclosure. As shown in FIG. 5, in this embodiment, PRACHs are divided into four coverage enhancement levels, CE0, CE1, CE2 and CE3. Each of the coverage enhancement levels corresponds to a PRACH repetition window having a fixed window length. Each PRACH having a coverage enhancement level has an RAR having a corresponding coverage enhancement level. Each RAR having a coverage enhancement level corresponds to an RAR repetition window having a fixed window length.

The base station 100 can configure the same size of RAR windows for different coverage enhancement levels of RARs (or different coverage enhancement levels of PRACHs). In the example shown in FIG. 5, the size of an RAR window refers to the number of RAR repetition windows. For example, the base station 100 can configure a size 5 of RAR window for the coverage enhancement levels CE0/CE1/CE2/CE3 of RARs, i.e., 5 RAR repetition windows for the respective coverage enhancement levels.

The configuration information for the size of the RAR window can be preconfigured or can be notified to the MTC UE via MIB (Master Information Block) or SIBx (System Information Block, SIB, 1, and/or SIB2 and/or other SIBs), MAC PDU, or dedicated RRC signaling.

FIG. 6 is a schematic diagram showing the same size of RAR windows configured for different coverage enhancement levels of subframes according to an embodiment of the present disclosure. As shown in FIG. 6, in this embodiment, PRACHs are divided into four coverage enhancement levels, CE0, CE1, CE2 and CE3. Each of the coverage enhancement levels corresponds to a PRACH repetition window having a fixed window length. Each PRACH having a coverage enhancement level has an RAR having a corresponding coverage enhancement level. Each RAR having a coverage enhancement level corresponds to an RAR repetition window having a fixed window length.

The base station 100 can configure the same of RAR windows for different coverage enhancement levels of RARs (or different coverage enhancement levels of PRACHs). In the example shown in FIG. 6, the size of an RAR window refers to the number of downlink subframes. For example, the base station 100 can configure a size 200 of RAR window for the coverage enhancement levels CE0/CE1/CE2/CE3 of RARs, i.e., 200 downlink subframes.

The configuration information for the size of the RAR window can be preconfigured or can be notified to the MTC UE via MIB (Master Information Block) or SIBx (System Information Block, SIB, 1, and/or SIB2 and/or other SIBs), MAC PDU, or dedicated RRC signaling.

In the conventional LTE system, after transmitting a random access preamble sequence, a UE monitors a PDCCH in an RAR window. If an RAR is detected (a corresponding PDCCH is detected using RA-RNTI), and no identifier of the random access preamble sequence transmitted by the UE itself, but instead a back-off indicator, is detected in the corresponding MAC PDU, it can be determined that the preamble sequence has been detected by the eNB, but there is more than one preamble sequence using the same time-frequency resources to transmit random access requests (the respective UEs have the same RA-RNTI). In this case, the UE sets its back-off time to a value indicated by the back-off indicator and notifies the upper layer of failure of the random access attempt. If the notification of failure of the random access attempt is received by the upper layer and the number of retransmissions has not reached the specified upper limit, the UE select a time delay randomly in the range from 0 to the back-off time period for retransmitting the random access preamble sequence. For example, the value of the back-off parameter is measured in units of milliseconds (subframes), as shown in Table 4 below.

TABLE 4

| Index | Back-off Parameter Value (ms) |
|---|---|
| 0 | 0 |
| 1 | 10 |
| 2 | 20 |
| 3 | 30 |
| 4 | 40 |
| 5 | 60 |
| 6 | 80 |
| 7 | 120 |
| 8 | 160 |
| 9 | 240 |
| 10 | 320 |
| 11 | 480 |
| 12 | 960 |
| 13 | Reserved |
| 14 | Reserved |
| 15 | Reserved |

For an MTC UE with coverage enhancement, a PRACH needs to be transmitted repeatedly for a number of times, so as to meet the requirements of its coverage enhancement level. PRACHs having different coverage enhancement levels require different numbers of repetitive transmissions, i.e., different window lengths of PRACH repetition windows. For example, as shown in FIG. 3, four coverage enhancement levels of PRACHs have four different window lengths of repetition windows. The MTC UE with coverage enhancement can use a back-off mechanism similar to that in the conventional LTE system. The specific implementations will be described below.

Implementation 1—As shown in Table 4, the parameter values in the back-off time parameter table are measured in units of milliseconds (ms).

MTC UEs having different coverage enhancement levels of PRACHs can use the same back-off time parameter table. However, MTC UEs having different coverage enhancement levels of PRACHs can configure the same or different back-off time. The back-off time parameter table can be the parameter table in the conventional LTE system (e.g., Table 4), or can be a newly designed parameter table.

Alternatively, MTC UEs having different coverage enhancement levels of PRACHs can use different back-off time parameter tables. For example, the coverage enhancement level CE0 of PRACH can use the conventional table (Table 1), whereas the other coverage enhancement levels may have newly designed back-off time parameter tables.

Alternatively, all the coverage enhancement levels of PRACHs can be divided into a number of groups and MTC UEs belonging to different groups use different back-off time parameter tables. For example, four coverage enhancement levels of PRACHs can be divided into two groups, Group 1 containing CE0 and CE1, and Group 2 containing CE2 and CE3. Group 1 and Group 2 use different back-off time parameter tables.

Implementation 2—As shown in Table 5, the parameter values in the back-off time parameter table are measured in units of PRACH repetition windows.

MTC UEs having different coverage enhancement levels of PRACHs can use the same back-off time parameter table. However, MTC UEs having different coverage enhancement levels of PRACHs can configure the same or different back-off time.

Alternatively, MTC UEs having different coverage enhancement levels of PRACHs can use different back-off time parameter tables. For example, the coverage enhancement level CE0 of PRACH can use Table 5 as its back-off time parameter table, whereas the other coverage enhancement levels may have newly designed back-off time parameter tables.

Alternatively, all the coverage enhancement levels of PRACHs can be divided into a number of groups and MTC UEs belonging to different groups use different back-off time parameter tables. For example, four coverage enhancement levels of PRACHs can be divided into two groups, Group 1 containing CE0 and CE1, and Group 2 containing CE2 and CE3. Group 1 and Group 2 use different back-off time parameter tables.

TABLE 5

| Index | Back-off Parameter Value (rw) |
|---|---|
| 0 | 0 |
| 1 | 10 |
| 2 | 20 |
| 3 | 30 |
| 4 | 40 |
| 5 | 60 |
| 6 | 80 |
| 7 | 120 |
| 8 | 160 |
| 9 | 240 |
| 10 | 320 |
| 11 | 480 |
| 12 | 960 |
| 13 | Reserved |
| 14 | Reserved |
| 15 | Reserved |

Note:
rw represents the number of PRACH repetition windows

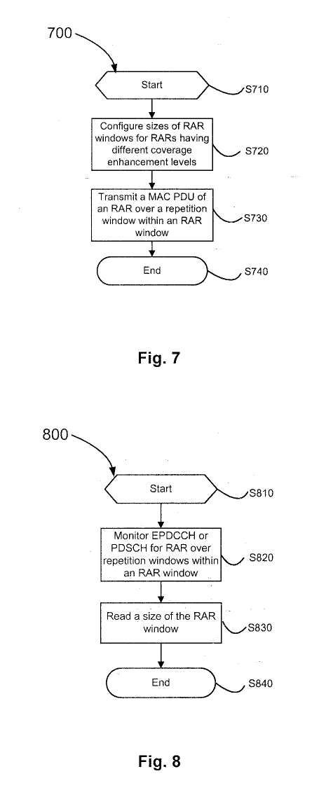

FIG. 7 is a flowchart illustrating a method performed by a base station according to an embodiment of the present disclosure. As shown in FIG. 7, the method 700 starts with step S710.

At step S720, the base station can configure the same or different sizes of RAR windows for different coverage enhancement levels of RARs (or different coverage enhancement levels of PRACHs). The base station can also configure the same or different back-off time parameter tables for different coverage enhancement levels of PRACHs (or different coverage enhancement levels of PRACHs). Preferably, a size of an RAR window is represented as a number of RAR repetition windows.

At step S730, preferably, after receiving the random access preamble sequence transmitted from the UE, the base station transmits a Media Access Control (MAC) Protocol Data Unit (PDU) of an RAR repeatedly for a number of times over an RAR repetition window within an RAR window that corresponds to the RAR preamble sequence, starts with the last subframe of the last one or more repetitive receptions of the preamble sequence by the base station over PRACH+k subframes and has ra-ResponseWindowSize-MTC RAR repetition windows, where k is a constant which can be a preset value or can be configured by the base station. Each MAC PDU consists of one MAC header, zero or more MAC RARs and an optional padding field. The exact number of repetitive transmissions is dependent on the number of repetitive transmissions configured for the repetition window of the coverage enhancement level.

At step S730, alternatively, after receiving the random access preamble sequence transmitted from the UE, the base station transmits a Media Access Control (MAC) Protocol Data Unit (PDU) of an RAR repeatedly for a number of times over one of n RAR repetition windows within an RAR window that corresponds to the RAR preamble sequence, starts with the last subframe of the last one or more repetitive receptions of the preamble sequence by the base station over PRACH+k subframes and has ra-ResponseWindowSize-MTC subframes, where k is a constant which can be a preset value or can be configured by the base station and n is an integer value depending on ra-ResponseWindowSize-MTC, the window length of the RAR repetition window and an interval between two neighboring RAR repetition windows. Each MAC PDU consists of one MAC header, zero or more MAC RARs and an optional padding field. The exact number of repetitive transmissions is dependent on the number of repetitive transmissions configured for the repetition window of the coverage enhancement level.

Preferably, different sizes of RAR windows can be configured for different coverage enhancement levels of RARs. Alternatively, the same size of RAR windows can be configured for different coverage enhancement levels of RARs

Preferably, different coverage enhancement levels of Physical Random Access Channels (PRACHs) have the same or different back-off time parameter tables. Here, values in each back-off time parameter table can be measured in units of PRACH repetition windows.

Finally, the method 700 ends with step S740.

FIG. 8 is a flowchart illustrating a method performed by a UE according to an embodiment of the present disclosure. As shown in FIG. 8, the method 800 starts with step S810.

At step S820, the UE reads configuration information of a size of the RAR window and/or back-off indication information based on a coverage enhancement level of its RAR. Alternatively, the UE reads configuration information of a size of the RAR window and/or back-off indication information based on a coverage enhancement level of PRACH over which the UE transmits the random access preamble sequence.

At step S830, preferably, after transmitting a random access preamble sequence, the UE monitors (E)PDCCH (M-PDCCH) or PDSCH for an RAR over ra-ResponseWindowSize-MTC RAR repetition windows within an RAR window that corresponds to the RAR preamble sequence, starts with the last subframe of the last one or more repetitive transmissions of the preamble sequence by the UE over PRACH+k subframes and has ra-ResponseWindowSize-MTC RAR repetition windows, where k is a constant which can be a preset value or can be configured by the base station. Each MAC PDU consists of one MAC header, zero or more MAC RARs and an optional padding field. The exact number of repetitive transmissions is dependent on the number of repetitive transmissions configured for the repetition window of the coverage enhancement level.

The (E)PDCCH (M-PDCCH) refers to (E)PDCCH (M-PDCCH) for scheduling the PDSCH carrying the RAR message. The (E)PDCCH can be an EPDCCH defined in the conventional LTE system or a newly designed narrow band PDCCH (M-PDCCH).

The PDSCH is a PDSCH carrying the RAR message without being scheduled by an (E)PDCCH (M-PDCCH). In this case, without scheduling by (E)PDCCH (M-PDCCH), the UE can directly monitor the PDSCH carrying the RAR message.

At step S830, alternatively, after transmitting a random access preamble sequence, the UE monitors (E)PDCCH (M-PDCCH) or PDSCH for an RAR over n RAR repetition windows within an RAR window that corresponds to the RAR preamble sequence, starts with the last subframe of the last one or more repetitive transmissions of the preamble sequence by the UE over PRACH+k subframes and has ra-ResponseWindowSize-MTC RAR subframes, where k is a constant which can be a preset value or can be configured by the base station and n is an integer value depending on ra-ResponseWindowSize-MTC, the window length of the RAR repetition window and an interval between two neighboring RAR repetition windows. Each MAC PDU consists of one MAC header, zero or more MAC RARs and an optional padding field. The exact number of repetitive transmissions is dependent on the number of repetitive transmissions configured for the repetition window of the coverage enhancement level.

The (E)PDCCH (M-PDCCH) refers to (E)PDCCH (M-PDCCH) for scheduling the PDSCH carrying the RAR message. The (E)PDCCH (M-PDCCH) can be an EPDCCH defined in the conventional LTE system or a newly designed narrow band PDCCH (M-PDCCH).

The PDSCH is a PDSCH carrying the RAR message without being scheduled by an (E)PDCCH (M-PDCCH). In this case, without scheduling by (E)PDCCH (M-PDCCH), the UE can directly monitor the PDSCH carrying the RAR message.

Preferably, different coverage enhancement levels of Physical Random Access Channels (PRACHs) have the same or different back-off time parameter tables. Here, values in each back-off time parameter table can be measured in units of PRACH repetition windows.

Finally, the method 800 ends with step S840.

It can be appreciated that the above embodiments of the present disclosure can be implemented in software, hardware or any combination thereof. For example, the internal components of the base station and the UE in the above embodiments can be implemented using various devices including, but not limited to, analog circuit device, digital circuit device, Digital Signal Processing (DSP) circuit, programmable processor, Application Specific Integrated Circuit (ASIC), Field Programmable Gate Array (FPGA), Programmable Logic Device (CPLD) and the like.

Further, the embodiments of the present disclosure can be implemented in computer program products. More specifically, a computer program product can be a product having a computer readable medium with computer program logics coded thereon. When executed on a computing device, the computer program logics provide operations for implementing the above solutions according to the present disclosure. When executed on at least one processor in a computing system, the computer program logics cause the processor to perform the operations (methods) according to the embodiments of the present disclosure. This arrangement of the present disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules. The software, firmware or arrangement can be installed in a computing device to cause one or more processors in the computing device to perform the solutions according to the embodiments of the present disclosure.

The present disclosure has been described above with reference to the preferred embodiments thereof. It should be understood that various modifications, alternations and additions can be made by those skilled in the art without departing from the spirits and scope of the present disclosure. Therefore, the scope of the present disclosure is not limited to the above particular embodiments but only defined by the claims as attached and the equivalents thereof.

1.-24. (canceled)

25. A User Equipment (UE), comprising:
reception circuitry configured to receive a configuration configuring a random access response window size per enhanced coverage level, and
extraction circuitry configured to configure the random access response window size per enhanced coverage level in accordance with the received configuration.

26. The UE of claim 25, wherein values of random access response window sizes for coverage enhancement are larger than values of random access response window sizes for non-coverage enhancement.

27. A base station, comprising:
configuration circuitry configured to configure a configuration of a random access response window size per enhanced coverage level, and
transmission circuitry configured to transmit the configuration.

28. The base station of claim 27, wherein values of random access response window sizes for coverage enhancement are larger than values of random access response window sizes for non-coverage enhancement.

29. A method performed by a User Equipment (UE), comprising:
receiving a configuration configuring a random access response window size per enhanced coverage level, and
configuring the random access response window size per enhanced coverage level in accordance with the received configuration.

30. A method performed by a base station, comprising:
configuring a configuration of a random access response window size per enhanced coverage level, and
transmitting the configuration.
